(19) United States
(12) Patent Application Publication
(10) Pub. No.: US 2021/0133080 A1
(43) Pub. Date: May 6, 2021

(54) INTERPRETABLE PREDICTION USING EXTRACTED TEMPORAL AND TRANSITION RULES

(71) Applicant: NEC Laboratories America, Inc., Princeton, NJ (US)

(72) Inventors: Wei Cheng, Princeton Junction, NJ (US); Shuchu Han, Princeton Junction, NJ (US); Haifeng Chen, West Windsor, NJ (US)

(21) Appl. No.: 17/072,526

(22) Filed: Oct. 16, 2020

Related U.S. Application Data
(60) Provisional application No. 62/927,749, filed on Oct. 30, 2019.

(51) Int. Cl. G06F 11/34; G06F 11/30; G06F 11/07

(52) U.S. Cl. CPC G06F 11/3495; G06F 11/0793; G06F 11/3419; G06F 11/3072

(57) ABSTRACT

Methods and systems for detecting and responding to anomalous system behavior include detecting an anomaly in a cyber-physical system, based on a classification of time series information, from sensors that monitor the cyber-physical system, as being anomalous. A transition rule is extracted from the time series information to characterize a cause of the anomalous behavior, using a temporal gradient boosting tree. A corrective action is performed responsive to the detected anomaly, prioritized by the cause of the anomalous behavior.

### RELATED APPLICATION INFORMATION

This application claims priority to U.S. Patent Application Ser. No. 62/927,749, filed on Oct. 30, 2019, incorporated herein by reference entirety.

### BACKGROUND

### Technical Field

The present invention relates to identifying transition patterns in time series, and, more particularly, to finding rules that explain a classification for a time series.

### Description of the Related Art

While attempts have been made to extract general rules, there exists no process by which the transition rules of time series can be extracted.

### SUMMARY

A method for detecting and responding to anomalous system behavior includes detecting an anomaly in a cyber-physical system, based on a classification of time series information, from sensors that monitor the cyber-physical system, as being anomalous. A transition rule is extracted from the time series information to characterize a cause of the anomalous behavior, using a temporal gradient boosting tree. A corrective action is performed responsive to the detected anomaly, prioritized by the cause of the anomalous behavior.

A system for detecting and responding to anomalous system behavior includes a hardware processor and a memory, configured to store a computer program product. When executed by the hardware processor, the computer program product implements anomaly detection code, rule extraction code, and abnormal behavior response code. The anomaly detection code detects an anomaly in a cyber-physical system, based on a classification of time series information, from sensors that monitor the cyber-physical system, as being anomalous. The rule extraction code extracts a transition rule from the time series information, to characterize a cause of the anomalous behavior, using a temporal gradient boosting tree. The abnormal behavior response code performs a corrective action responsive to the detected anomaly, prioritized by the cause of the anomalous behavior.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a cyber-physical system that includes a variety of sensors to generate a multivariate time series, where the multivariate time series may indicate anomalous behavior, and where the detection of anomalous behavior may be characterized by extracted transition rules, in accordance with an embodiment of the present invention;

FIG. 2 is a diagram illustrating a multivariate time series that is classified according to a set of labels, in accordance with an embodiment of the present invention;

FIG. 3 is a block/flow diagram of a method for extracting transition rules from multivariate time series, which can be used to characterize the classification of such time series according to various labels, in accordance with an embodiment of the present invention;

FIG. 4 is a diagram of an exemplary transition rule tree, which may be used to characterize the classification of a multivariate time series according to normal/abnormal behavior, in accordance with an embodiment of the present invention; and

FIG. 5 is a block diagram of a behavior evaluation and response system that can be used to characterize the classification of such time series according to various labels, in accordance with an embodiment of the present invention.

### DETAILED DESCRIPTION OF PREFERRED EMBODIMENTS

Machine learning classification effectively applies labels to time series, based on a set of training information that can include many different examples of different circumstances. However, once trained, the operation of the machine learning classifier can often be inscrutable, making it difficult to come to an understanding of what characteristics of the time series lead to the classification outcome.

Transition rules can thus be extracted from the time series that explain which circumstances in a time series are associated with which labels. For example, attribute-based transition rules and ratio-based transition rules can be extracted, as described below. Once transition rules have been extracted, they can be used for a variety of applications, such as anomaly detection. Explicit rules provide interpretability for the classification results, and can also be used by domain experts to check the effectiveness of the classifier.

Considering anomaly detection in particular, a label may indicate that a time series is normal or abnormal. A transition rule may determine whether a particular attribute value is smaller or larger than a threshold for some number of time periods. The extracted rules denote that some condition is satisfied for a period of time. In the case of anomaly detection, this can indicate that the abnormal operation is getting worse with time.

In another example, transition rules can be extracted for a system's performance over time, to provide a determination of the system's effectiveness over that time. The extracted rules can then be used to predict the system's performance into the future and can be used to evaluate a likelihood of success at particular tasks.

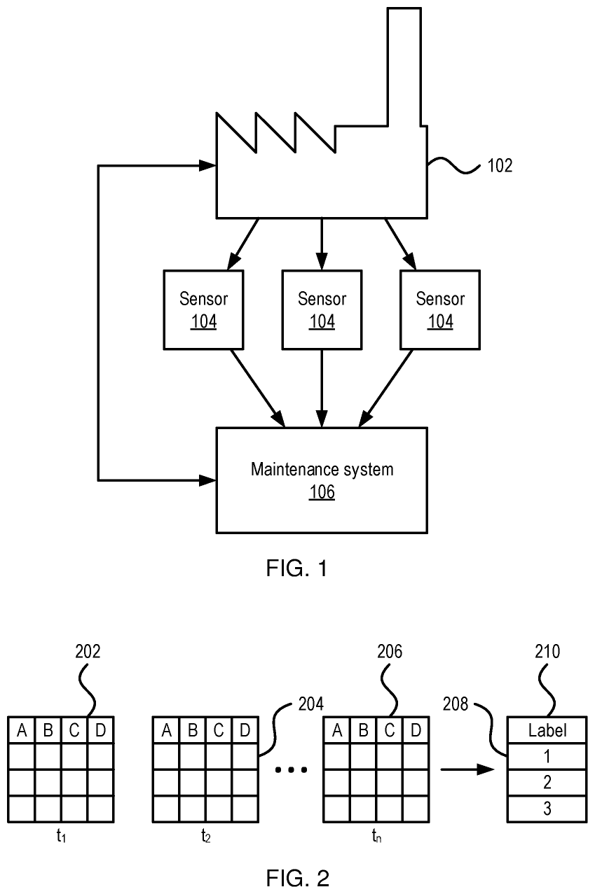

Referring now in detail to the figures in which like numerals represent the same or similar elements and initially to FIG. 1, a maintenance system 106 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems.

One or more sensors 104 record information about the state of the monitored system 102. The sensors 104 can be any appropriate type of sensor including, for example, physical sensors, such as temperature, humidity, vibration, pressure, voltage, current, magnetic field, electrical field, and light sensors, and software sensors, such as logging utilities installed on a computer system to record information regarding the state and behavior of the operating system and applications running on the computer system. The information generated by the sensors 104 can be in any appropriate format and can include sensor log information generated with heterogeneous formats.

In particular embodiments, the sensor data 104 can also include a KPI measurement. In some embodiments, the KPI measurement may be the result of an inspection of a physical output of the monitored system 102, or can represent a determination of a quality of the physical output by any appropriate measurement or characteristic.

The sensors 104 may transmit the logged sensor information to an anomaly maintenance system 106 by any appropriate communications medium and protocol, including wireless and wired communications. The maintenance system 106 can, for example, identify abnormal behavior by monitoring the multivariate time series that are generated by the sensors 104. Once anomalous behavior has been detected, the maintenance system 106 communicates with a system control unit to alter one or more parameters of the monitored system 102 to correct the anomalous behavior. Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects or mitigates the anomalous behavior. By identifying the particular sensors 104 that are associated with the anomalous classification, the amount of time needed to isolate a problem can be decreased.

In addition to the classification of time series as being normal or anomalous, the maintenance system 106 can extract transition rules that characterize the operation of the classifier. These rules can provide further indications as to which sensors 104 are involved with anomalous behavior, and can guide decisions about how best to resolve the anomaly.

Referring now to FIG. 2, an exemplary time series is shown. Consider a set of distinct monitored systems 102. Measurements 202 are taken from the sensors 104 of the respective facilities at each of a series of n time steps, designated t₁, t₂, . . . , tₙ. The value n may be regarded as a hyperparameter that defines the number of time steps that may be considered for identifying transition patterns. Each of the measurements 202 can be broken down into the output of one or more monitored systems 102, with each monitored system 102 taking up a row of a single measurement table 202. The sensors 104 represent columns. A given monitored system 102 may have one or more sensors 104 that serve a same purpose in another monitored system 102, and so measurements for these sensors 104 may share a single column. The columns are designated according to an identifier of the sensor, herein represented as ‘A’, ‘B’, etc. These columns may therefore store numerical values that reflect the measurement outputs of the respective sensors. These organizations of data within the time series are introduced solely for the sake of illustration, and should not be construed as limiting—any appropriate time series format may be used instead.

In addition to the inclusion of numerical sensor outputs, additional columns may be included that represent categorical information. Categorical information may be static, such as a make and model number for the monitored system 102, but may also change over time, such as when the operational status of the monitored system 102 is changed. The columns that correspond to categorical attributes are represented herein as ‘E’, ‘F’, etc. It should be understood that any number of numerical and categorical columns may be used, and that it need not be the case that every measured system 102 shares the same attributes.

The time series is associated with a set of labels 210. In particular, each row 204 is associated with a respective label 208, for example identifying whether a particular system is behaving in an anomalous fashion. These labels may be determined by a machine learning classifier, trained on a set of training time series that have a format similar to the format used during classification.

A first type of transition rule that may be extracted from the time series is an attribute-based rule, which compares a particular attribute (e.g., the ‘Aₙ’ value for each measurement 202 across the n measurements) to a threshold. A second type of transition rule that may be extracted from the time series is a ratio-based rule, which compares the ratios of successively measured attributes (e.g., Aₙ/Aₙ₋₁) to a threshold. If the respective values meet the threshold condition for n consecutive measurements, then the respective rule may be extracted.

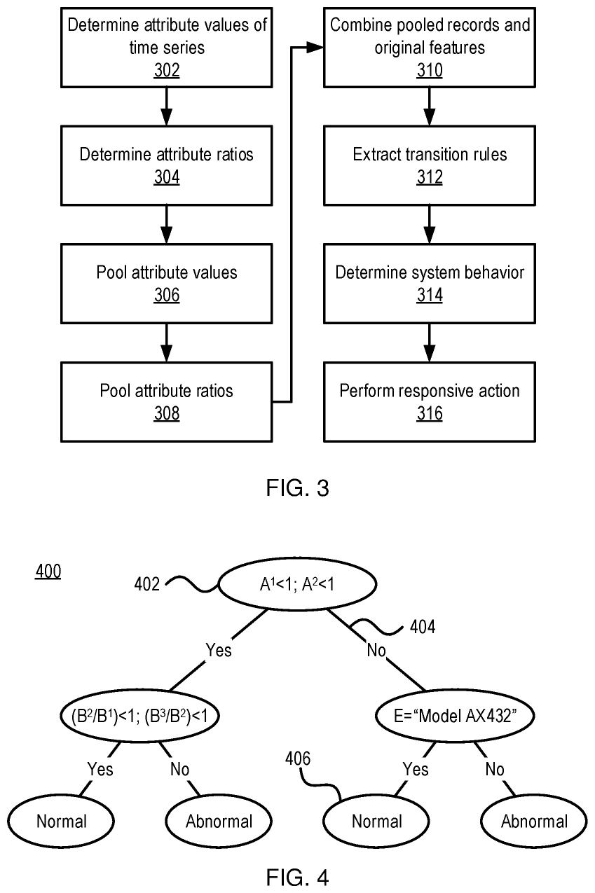

Referring now to FIG. 3, a method is shown for extracting transition rules for system behavior and responding to such behavior. Block 302 determines attribute values of the time series. For example, block 302 determines the values of the attribute ‘A’ for each of the n measurement time steps. Thus, block 302 may determine a series of values A₁, A₂, . . . Aₙ. Block 304 then determines the ratios of consecutive values of the attribute. Thus, for example, block 304 may determine a series of values A₂/A₁, A₃/A₂, . . . , Aₙ/Aₙ₋₁.

Block 306 max pools the values output by block 302. For example, the output of block 302 may be pooled by finding the maximum of each set of n attribute values. Thus, for example, if n=3, the first max pooled attribute value may be max(A₁, A₂, A₃). Block 308 pools the ratios output by block 304. For example, the output of block 304 may be pooled by finding the maximum of each set of n−1 attribute ratios. Thus, if n=3, the first max pooled ratio may be max (A₂/A₁, A₃/A₂). Blocks 302, 304, 306, and 308 may be performed for each of the attributes (e.g., ‘A,’ ‘B,’ ‘C,’ etc.).

Block 310 may combine the pooled records and original categorical features into a single input. Thus, a given combined input may be expressed as:

| | | | | | | | | |
|---|---|---|---|---|---|---|---|---|
| E | F | G | APool(A) | APool(B) | APool(C) | RPool(A) | RPool(B) | RPool(C) |

where E, F, and G are original categorical features, APool(⋅) is the max pooled attribute values from block 306 for an attribute, and RPool(⋅) is the max pooled attribute ratios from block 308 for an attribute.

Block 312 extracts the transition rules from the input. Block 312 may, for example, use a multiple regression tree for this. In particular, a temporal gradient boosting tree can be used for reliable results and for scalability, as will be described in greater detail below.

Gradient boosting is an iterative process that uses a set of base “learners,” which in this case may be small decision trees, and adds a new decision tree branch at each iteration to better reflect the circumstances reflected in the combined input. Because the combined input captures not only the attribute values themselves, but also their time-dependent variations, the rules that are extracted more completely reflect how the transitions from one state of the monitored system 102 to the next lead to the label determination. Thus, for example, the extracted rule may reflect a combined decision tree that recognizes a change in a particular attribute (e.g., if the ratio between two successive values of the ‘B’ sensor is large, or has a sustained level) as being indicative of abnormal behavior in the system.

Block 314 uses machine learning classification to determine the behavior of the system, for example determining whether the behavior is normal or abnormal. Block 316 then performs an action responsive to the determination. The responsive action can be guided according to an interpretation of the label, for example using extracted transition rules to identify particular sensors 104 associated with the abnormal behavior.

As noted above, a temporal gradient boosting tree can be used to extract the transition rules. Gradient boosting can be used for regression and classification systems to produce a prediction model, in the form of an ensemble of decision trees, in a stage-wise fashion. The decision trees can then be generalized by optimization of a differentiable loss function.

Referring now to FIG. 4, an exemplary decision tree 400 with transition rules is shown. This decision tree may have a set of nodes 402, with each of a set of branches 404 connecting a parent node to a child node. Each node 402 of the tree 400 represents a condition, which may evaluate to “true” or “false,” and may represent conditions relating to the various numerical and categorical attributes of a monitored system 102.

Thus, for example, the root node may indicate a numerical measurement on sensor A, at times t=1 and t=2, designated A¹ and A², respectively. If the root node evaluates to “true,” such that the value for A¹ and A² both evaluate to less than 1, then the left branch is evaluated next; otherwise the right branch is evaluated next. The measurements 202 of the monitored system 102 are thus compared against each decision rule until a leaf node 406 is reached. In this case, the leaf nodes 406 recognize two potential labels, but it should be understood that non-binary tree structures and conditions more labels may be used as well. The tree 400 may thus be traversed until a prediction of the label as being either “normal” or “abnormal” is reached.

The conditions in the nodes 402 may reflect direct attribute values, but may also include conditions relating to the ratios of attribute values in successive measurements. The conditions in the nodes 402 may also include non-numerical values, such as those relating to categorical attributes. Categorical attributes may be expressed as any appropriate datatype, such as a string of alphanumeric text. Thus, for example, the categorical information may reflect a particular model number of the monitored system 102. A given node 402 may include multiple different kinds of conditions.

The leaf nodes of the tree can be output, with the path to each leaf corresponding to a respective decision rule. Each leaf node also represents how many samples satisfy the rule in the training data. For each leaf node, in association with the number of samples that are labeled with different labels, can be used to calculate a ratio of the majority label samples. The number of samples satisfying the rule of a leaf node can be interpreted as a support score, and the ratio of the majority label samples can be interpreted as a confidence score. The support and confidence scores can be used to prioritize the importance of different rules to the label outcome.

The decision rule is assigned as a major class label of samples in the leaf node. Each leaf node denotes one decision rule, and it is associated with one “support” and one “confidence” value. The rules with larger “support” and “confidence” values may be regarded as being more important, and can be considered to be more informative. For example, if 100 samples satisfy a rule, with 89 being negative and 11 being positive, and with 1000 total training samples, then the support value may be 100/1000=0.1 and the confidence value may be 89/100=0.89. These scores can thus be used to determine how to perform the responsive action in block 316, with the sensors 104 contributing to a high-scoring rule being more relevant to the labeled condition.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

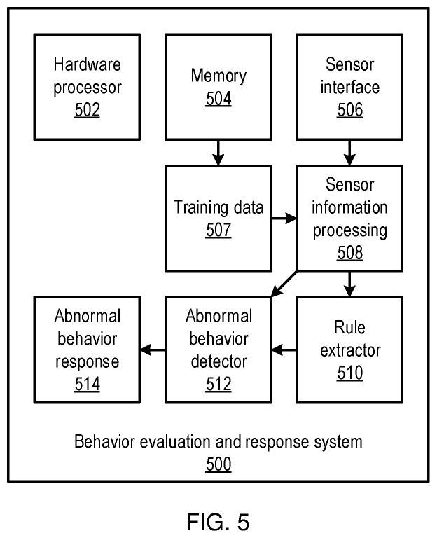

Referring now to FIG. 5, a behavior evaluation and response system 500 is shown. The system 500 includes a hardware processor 502 and a memory 504. The hardware processor 502 may implement various functions by executing software that is stored in the memory 504. In some cases, one or more functions may be implemented as one or more discrete hardware components, for example in the form of an application specific integrated chip or field programmable gate array.

A sensor interface 506 collects information regarding the sensors 104 of one or more monitored systems 102. The sensor interface 506 may receive the information directly from the sensors 104, for example via a dedicated interface, or may receive the information via a network, by any appropriate wired or wireless communications medium or protocol.

The sensor information collected by the sensor interface 506 is processed by sensor information processing 508. For example, the sensor information processing 508 may take a time series of measurements for various sensors and categorical attributes of the monitored system 102, and may perform pooling operations on numerical attribute values and the ratios between numerical attribute values.

Additionally, a set of training data 507 may be stored in memory 504, and may represent historical measurements taken from the monitored system 102, or from similar systems. The training data 507 may furthermore include classifications for each time series, labeling the respective monitored systems 102 according to some classification, such as normal behavior and abnormal behavior. This training data 507 may be used by a rule extractor 510 to determine one or more rules. The rule extractor may use temporal gradient boosting to generate a decision tree that includes temporal conditions to represent a rule.

Abnormal behavior detector 512 uses the rule to predict a classification for a new set of processed sensor information. Based on the rule, and on recent sensor information, abnormal behavior detector 512 makes a determination of whether the sensor information indicates normal or abnormal behavior in the system 102. Abnormal behavior detector 512 may include multiple such rules, testing recent sensor information against each of them to determine different abnormal conditions. The rule can then be used to indicate which of the sensors 104 relate most to the abnormal condition, for example indicating the sensors whose attributes are included in the decision tree of the rule.

Once abnormal behavior is detected, abnormal behavior response 514 can provide a response to correct the abnormality. For example, abnormal behavior response 514 can perform an intervention in the monitored system 102, directed at changing some variable that is measured by the sensors 104. In one specific example, if the sensors 104 indicate an elevated temperature, leading to a potential failure, the abnormal behavior response 514 may trigger a cooling system to reduce the system temperature. The abnormal behavior response may therefore prioritize its intervention activity to address those sensors which are most closely related to the classification outcome.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting and responding to anomalous system behavior, comprising:
detecting an anomaly in a cyber-physical system, based on a classification of time series information, from a plurality of sensors that monitor the cyber-physical system, as being anomalous;
extracting a transition rule from the time series information, using a processor, to characterize a cause of the anomalous behavior, using a temporal gradient boosting tree; and
performing a corrective action responsive to the detected anomaly, prioritized by the cause of the anomalous behavior.

2. The method of claim 1, further comprising pre-processing the time series information to include pooled attributes.

3. The method of claim 2, wherein pre-processing the time series information includes determining pooled attribute values and pooled attribute ratios.

4. The method of claim 3, wherein the attribute ratios include a ratio of a measured value of an attribute from a first time to a measured value of the attribute from a second time.

5. The method of claim 2, wherein the pooled attributes include multiple values of an attribute, processed by a maximizing pooling function.

6. The method of claim 1, wherein the transition rule is a decision tree that includes one or more temporal conditions.

7. The method of claim 6, wherein the one or more temporal conditions include an evaluation of a numerical value of an attribute as measured at multiple different times.

8. The method of claim 7, wherein the transition rule further includes an evaluation of a categorical attribute.

9. The method of claim 1, wherein performing the corrective action is prioritized according to one or more sensors that are represented in the transition rule.

10. A system for detecting and responding to anomalous system behavior, comprising:
a hardware processor;
a memory, configured to store a computer program product that, when executed by the hardware processor, implements:
anomaly detection code that detects an anomaly in a cyber-physical system, based on a classification of time series information, from a plurality of sensors that monitor the cyber-physical system, as being anomalous;
rule extraction code that extracts a transition rule from the time series information, to characterize a cause of the anomalous behavior, using a temporal gradient boosting tree; and
abnormal behavior response code that performs a corrective action responsive to the detected anomaly, prioritized by the cause of the anomalous behavior.

11. The system of claim 10, further comprising sensor processing code that pre-processes the time series information to include pooled attributes.

12. The system of claim 11, wherein the sensor processing code further determines pooled attribute values and pooled attribute ratios.

13. The system of claim 12, wherein the attribute ratios include a ratio of a measured value of an attribute from a first time to a measured value of the attribute from a second time.

14. The system of claim 11, wherein the pooled attributes include multiple values of an attribute, processed by a maximizing pooling function.

15. The system of claim 10, wherein the transition rule is a decision tree that includes one or more temporal conditions.

16. The system of claim 15, wherein the one or more temporal conditions include an evaluation of a numerical value of an attribute as measured at multiple different times.

17. The system of claim 16, wherein the transition rule further includes an evaluation of a categorical attribute.

18. The system of claim 10, wherein abnormal behavior response code prioritizes the corrective action according to one or more sensors that are represented in the transition rule.

19. A non-transitory computer readable storage medium comprising a computer readable program for detecting and responding to anomalous system behavior, wherein the computer readable program when executed on a computer causes the computer to perform the steps of:
detecting an anomaly in a cyber-physical system, based on a classification of time series information, from a plurality of sensors that monitor the cyber-physical system, as being anomalous;
extracting a transition rule from the time series information, using a processor, to characterize a cause of the anomalous behavior, using a temporal gradient boosting tree; and
performing a corrective action responsive to the detected anomaly, prioritized by the cause of the anomalous behavior.

20. The non-transitory computer readable storage medium of claim 19, wherein the computer readable program further causes the computer to perform the steps of:
pre-processing the time series information to determine pooled attribute values and pooled attribute ratios.
